(19) United States
(12) Patent Application Publication
(10) Pub. No.: US 2010/0079386 A1
(43) Pub. Date: Apr. 1, 2010

(54) HUMAN-MACHINE INTERFACE HAVING MULTIPLE TOUCH COMBINATORIAL INPUT

(76) Inventors: Steven J. Scott, Ocononowoc, WI (US); Thong T. Nguyen, Anaheim, CA (US); Greggory Cieslak, Greendale, WI (US); Thomas Lloyd Heidebrecht, Cambridge, WI (US); Pete J. Klein, Kenosha, WI (US); Gary Dan Dotson, Muskego, WI (US)

Correspondence Address: ROCKWELL AUTOMATION, INC/SR, 1201 SOUTH SECOND STREET, MAIL STOP E-F719, MILWAUKEE, WI, 53204, US

(21) Appl. No.: 12/242,215

(22) Filed: Sep. 30, 2008

(51) Int. Cl. G06F 3/041

(52) U.S. Cl. 345/173

(57) ABSTRACT

A Human-Machine Interface (HMI) system comprises a user interface, a processing system, and a machine interface. The user interface displays a multi-state enable option graphic selectable by a first touch from a user, that, when the first touch is maintained, enables a multi-state mode of a state option graphic having a plurality of modes comprising a single-state mode and the multi-state mode, displays the state option graphic selectable by a second touch from the user, and receives the second touch from the user selecting the state option graphic. If the state option graphic is in the multi-state mode when selected, the processing system processes the second touch to select a state option from a plurality of state options corresponding to a plurality of operation states of a machine. If the state option graphic is in the single-state mode when selected, the processing system processes the second touch to select the state option from a single state option corresponding to a single operation state of the machine. The machine interface transfers a control instruction to operate the machine in an operation state corresponding to the state option.

### TECHNICAL FIELD

The invention is related to the field of human-machine interfaces, and in particular, to a method and system for operating a human-machine interface.

### TECHNICAL BACKGROUND

Industrial environments include automobile manufacturing factories, food processing plants, and microprocessor fabrication facilities. The typical industrial environment includes various machines, such as pumps, motors, and robots. These machines continually produce data that indicates the current status of the machines, such as the machine's pressure, temperature, or speed.

The typical industrial environment also includes a Human-Machine Interface (HMI). The HMI receives and processes the status data from the machines to generate various graphical displays. The graphical displays indicate the current and historical status of the machines. For example, an HMI graphical display might indicate the pressure of a pump, the speed of a motor, or the output of a robot. The HMI may also control the machines. For example, the HMI might turn on a pump, speed-up a motor, or stop a robot.

The HMI may display various options for controlling a machine. Unfortunately, the user must operate traditional input devices such as a keyboard and mouse to select the many available operation modes. This method of selecting machine operation modes may be too slow, inefficient, or cumbersome for some users.

### TECHNICAL SUMMARY

A Human-Machine Interface (HMI) system comprises a user interface, a processing system, and a machine interface. The user interface displays a multi-state enable option graphic selectable by a first touch from a user, that, when the first touch is maintained, enables a multi-state mode of a state option graphic having a plurality of modes comprising a single-state mode and the multi-state mode, displays the state option graphic selectable by a second touch from the user, and receives the second touch from the user selecting the state option graphic. If the state option graphic is in the multi-state mode when selected, the processing system processes the second touch to select a state option from a plurality of state options corresponding to a plurality of operation states of a machine. If the state option graphic is in the single-state mode when selected, the processing system processes the second touch to select the state option from a single state option corresponding to a single operation state of the machine. The machine interface transfers a control instruction to operate the machine in an operation state corresponding to the state option.

In some examples, the operation state is one of the plurality of operation states of the machine.

In some examples, the operation state is the single operation state of the machine.

In some examples, the operation state comprises a rate of operating the machine.

In some examples, the multi-state enable option graphic and the state option graphic comprise interlocked momentary push buttons operable to cause a jog operation of the machine.

In some examples, the operation state comprises a movement of the machine.

In some examples, the user interface comprises a multi-touch screen.

Also disclosed herein is a method of operating a Human-Machine Interface (HMI) system wherein the method comprises displaying on a user interface a multi-state enable option graphic selectable by a first touch from a user, that, when the first touch is maintained, enables a multi-state mode of a state option graphic having a plurality of modes comprising a single-state mode and the multi-state mode, displaying on the user interface the state option graphic selectable by a second touch from the user, receiving the second touch from the user selecting the state option graphic, if the state option graphic is in the multi-state mode when selected, processing the second touch to select a state option from a plurality of state options corresponding to a plurality of operation states of a machine, if the state option graphic is in the single-state mode when selected, processing the second touch to select the state option from a single state option corresponding to a single operation state of the machine, and transferring a control instruction to operate the machine in an operation state corresponding to the state option.

Also disclosed herein is a software product configured to operate a Human-Machine Interface (HMI) system. The software product comprises HMI operation software, HMI interface software, and a storage system that stores the HMI operation software and the HMI interface software. The HMI interface software is configured to direct a user interface to display a multi-state enable option graphic selectable by a first touch from a user, that, when the first touch is maintained, enables a multi-state mode of a state option graphic having a plurality of modes comprising a single-state mode and the multi-state mode, display the state option graphic selectable by a second touch from the user, and receive the second touch from the user selecting the state option graphic. If the state option graphic is in the multi-state mode when selected, the HMI operation software is configured to direct a processing system to process the second touch to select a state option from a plurality of state options corresponding to a plurality of operation states of a machine. If the state option graphic is in the single-state mode when selected, the HMI operation software is configured to direct the processing system to process the second touch to select the state option from a single state option corresponding to a single operation state of the machine. The HMI interface software is configured to direct a machine interface to transfer a control instruction to operate the machine in an operation state corresponding to the state option.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a block diagram illustrating an industrial environment.

FIG. 2 is a block diagram illustrating an HMI system.

FIG. 3 is a flow diagram illustrating a method of operating an industrial environment.

FIG. 4 is a flow diagram illustrating a method of operating an industrial environment.

FIG. 5 is a display diagram illustrating an HMI system display.

FIG. 6 is a display diagram illustrating an HMI system display.

FIG. 7 is a display diagram illustrating an HMI system display.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Described herein is a system and method for operating machines or processes using various displays in a Human-Machine Interface (HMI) system. An HMI system can provide a user a means to control machines or processes in an industrial environment. Many operators, managers, and other workers who interact with machinery using an HMI system desire to easily and conveniently operate the machinery using the HMI system display.

Examples of possible control instructions a user may select to operate machinery include a jog operation or selecting a state or mode of operation. A user may also select a state or mode of operating a machine, for example a rate of speed, such as slow, medium, or fast. A user may also control the movement of a machine, such as panning or tilting a camera or robotic arm. In addition, an HMI system may require combinatorial selection to prevent inadvertent touches. For example, as a safety precaution, the HMI system may require a user to place both hands, or even all ten fingers of both hands, on a user interface, prior to transferring a control instruction to operate a machine. It should be understood that not all ten fingers is required. Rather, a sufficient number of fingers touching a screen would be required, in this example, to ensure that a user has both hands engaged. For instance, at least one finger on one hand, and at least one finger on another hand would suffice to ensure that the user has both hands engaged.

In order to easily operate an HMI system and quickly issue control instructions to machines and processes, a user could utilize an HMI system incorporating a multi-touch screen capable of receiving multiple simultaneous touches from the user. The user could provide multiple touches on the surface of the touch screen, corresponding to selections of different control instructions to be issued to various machines and processes. The HMI system could then process the touches to determine the requested control instructions associated with the machines or processes selected. The HMI system could then transfer the control instructions to operate the machine or process.

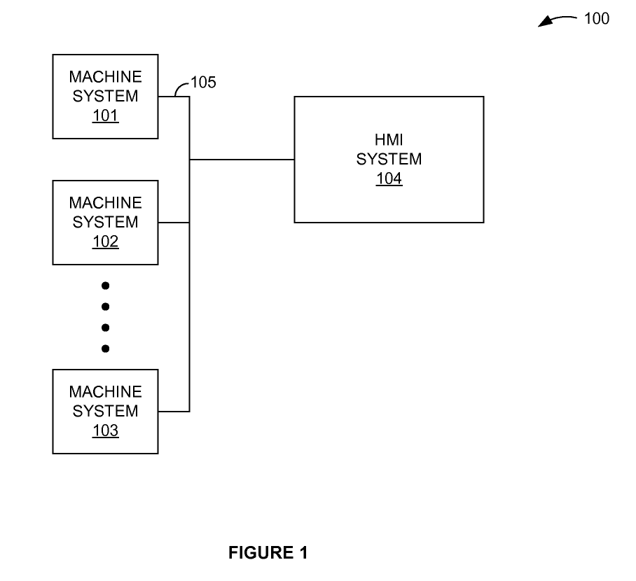

FIG. 1 is a block diagram illustrating industrial environment 100. Industrial environment 100 comprises machine systems 101-103, Human-Machine Interface (HMI) system 104, and communication system 105. The number of machine systems and HMI systems shown in FIG. 1 have been restricted for clarity, but there would typically be many more. Machine systems 101-103 and HMI system 104 communicate over communication system 105.

Industrial environment 100 includes machine systems 101-103, HMI system 104, and communication system 105. Industrial environment 100 comprises an automobile manufacturing factory, food processing plant, microprocessor fabrication facility, or some other type of industrial enterprise. Machine systems 101-103 comprise pumps, motors, robots, or some other mechanical apparatus, including their associated control systems. A control system comprises, for example, a programmable logic controller (PLC). Additionally, machine systems 101-103 comprise other, non-mechanical elements, such as a brew kettle in a brewery, a reserve of coal or other resources, or any other element that may reside in an industrial environment 100.

Machine systems 101-103 continually produce status data over time. The status data indicates the current status of machine systems 101-103, such as pressure, temperature, speed, or some other status metrics. The status data may comprise dynamic charts, real-time video, or some other graphical content. Machine systems 101-103 continually transfer the status data to HMI system 104 over communication system 105. In addition, HMI system 104 transfers control instructions to machine systems 101-103 over communication system 105. Communication system 105 could be a local area network, wide area network, or some other communication network—including combinations thereof.

HMI system 104 comprises computer and communication equipment and software. HMI system 104 continually receives the status data from machine systems 101-103. HMI system 104 also controls machine systems 101-103. For example, HMI system 104 might turn on a pump, speed-up a motor, stop a robot, boil a brew kettle, or perform some other type of machine control. An example of an HMI system that could be adapted in accord with this description is PanelView Plus™ supplied by Rockwell Automation. Other HMI systems are possible.

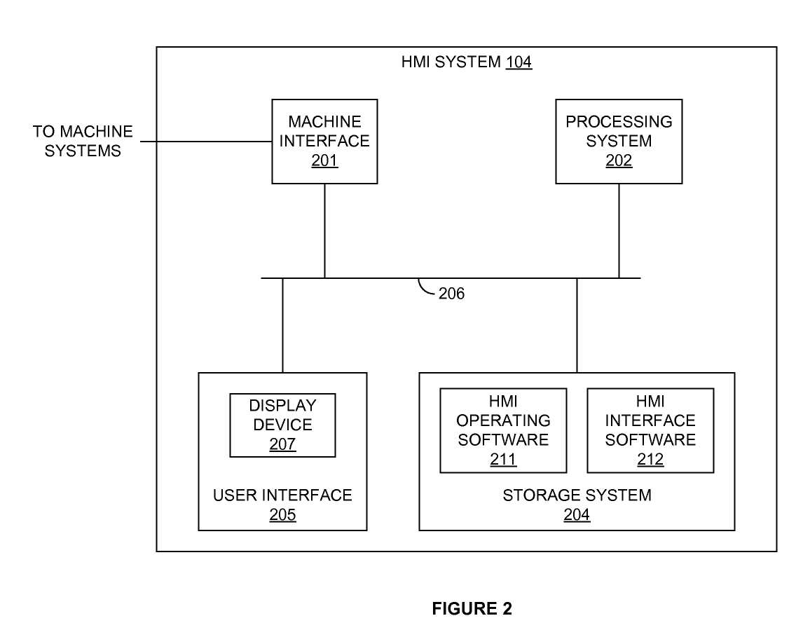

FIG. 2 is a block diagram illustrating HMI system 104. HMI system 104 comprises machine interface 201, processing system 202, storage system 204, user interface 205, and communication system 206. User interface 205 includes display device 207. Storage system 204 stores HMI operating software 211 and HMI interface software 212.

Machine interface 201 comprises communication circuitry and equipment that communicates with machine systems 101-103 over communication system 105. Processing system 202 comprises microprocessors or other logic circuitry that retrieves and executes HMI operating software 211.

User interface 205 comprises a touch screen, a touch pad, or some other user device. Display device 207 comprises a touch screen, liquid crystal display, cathode ray tube display, or some other graphical display mechanism. It should be understood that user interface 205 and display device 207 could comprise a single element providing for all user interaction, such as a touch screen. Additionally or alternatively, user interface 205 could comprise multiple user devices and multiple display devices, including a plurality of touch screens.

Storage system 204 comprises a disk, integrated circuit, flash drive, optical media, or some other memory device. Communication system 206 comprises a bus, local area network, or some other communication apparatus. The above-described components (201-207) of HMI system 104 may be integrated together or distributed among multiple devices.

HMI software 211-212 comprises an application program, firmware, or some other form of machine-readable processing instructions. HMI operating software 211 may include an operating system, utilities, drivers, networking, and applications. When executed by processing system 202, HMI software 211-212 directs HMI system 104 to operate as described herein. HMI interface software 212 comprises an application. An example of HMI interface software 212 is RS View supplied by Rockwell Automation. Other HMI interface software is possible.

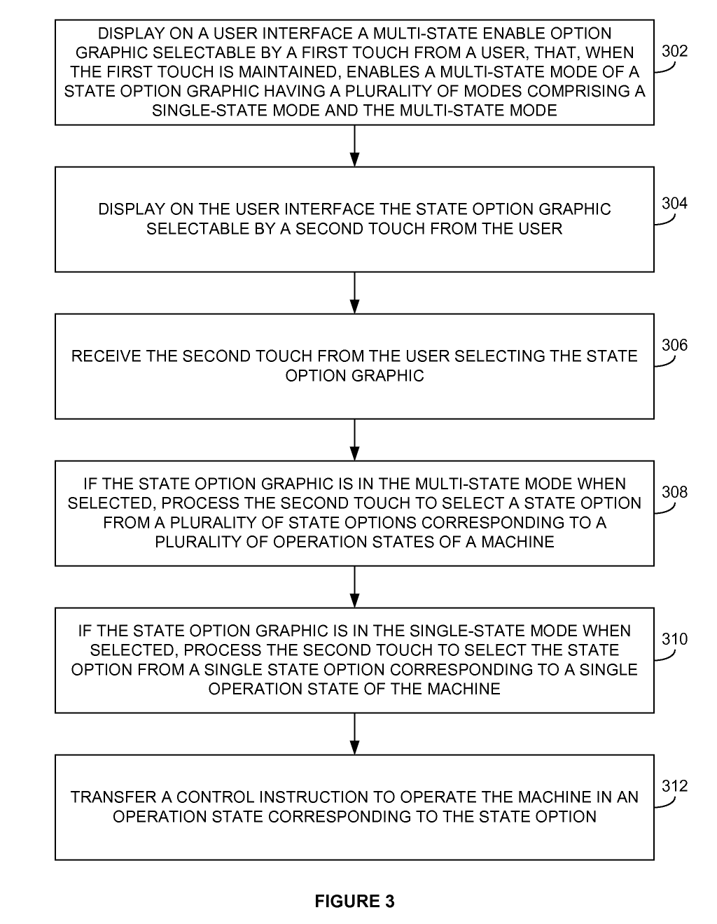

FIG. 3 is a flow diagram illustrating a method of operating industrial environment 100. HMI system 104 displays on a user interface a multi-state enable option graphic selectable by a first touch from a user, that, when the first touch is maintained, enables a multi-state mode of a state option graphic having a plurality of modes comprising a single-state mode and the multi-state mode (operation 302). HMI system 104 displays on the user interface the state option graphic selectable by a second touch from the user (operation 304).

The state option graphic performs a different function depending on whether or not the multi-state enable option is selected by a user. In one embodiment, the state option graphic starts or stops a machine or process when the multi-state enable option is not selected. In another embodiment, the state option graphic controls the speed of a machine or process while the multi-state enable option is selected.

HMI system 104 receives the second touch from the user selecting the state option graphic (operation 306). In one embodiment, the state option graphic is configured to control more than a single machine. In another embodiment, the state option graphic controls a process by controlling multiple machines to perform the process.

If the state option graphic is in the multi-state mode when selected, HMI system 104 processes the second touch to select a state option from a plurality of state options corresponding to a plurality of operation states of a machine (operation 308). The machine referred to in operation 308 could be a machine in machine systems 101-103, which could comprise pumps, motors, robots, vats, resources, or any other element residing in industrial environment 100. For example, the plurality of operation states of a vat might be a plurality of different pressure levels. Then, if the state option graphic is in the multi-state mode when selected, as in operation 308, the state option graphic would toggle between the plurality of available pressure levels.

If the state option graphic is in the single-state mode when selected, HMI system 104 processes the second touch to select the state option from a single state option corresponding to a single operation state of the machine (operation 310). For example, the single operation state of a motor might correspond to starting the motor. Then, if the state option graphic is in the single-state mode when selected, as in operation 310, the state option graphic would start the motor's operation.

In response to the user selections, HMI system 104 transfers a control instruction to operate the machine in an operation state corresponding to the state option (operation 312). If the state option corresponds to one of the plurality of operation states of the machine, as in operation 308, the control instruction will operate the machine according to the state selected from the plurality of operation states. However, if the state option corresponds to the single operation state of the machine, as in operation 310, the control instruction will operate the machine according to the single operation state.

It should be noted that HMI system 104 may be operated by multiple users simultaneously. In one embodiment, the first touch is provided by a first user, and the second touch is provided by a second user. In another embodiment, multiple users operate HMI system 104 by simultaneously providing distinct sets of a first and second touch. Accordingly, any reference to a singular user hereinabove or hereinafter comprises a single user or a plurality of users.

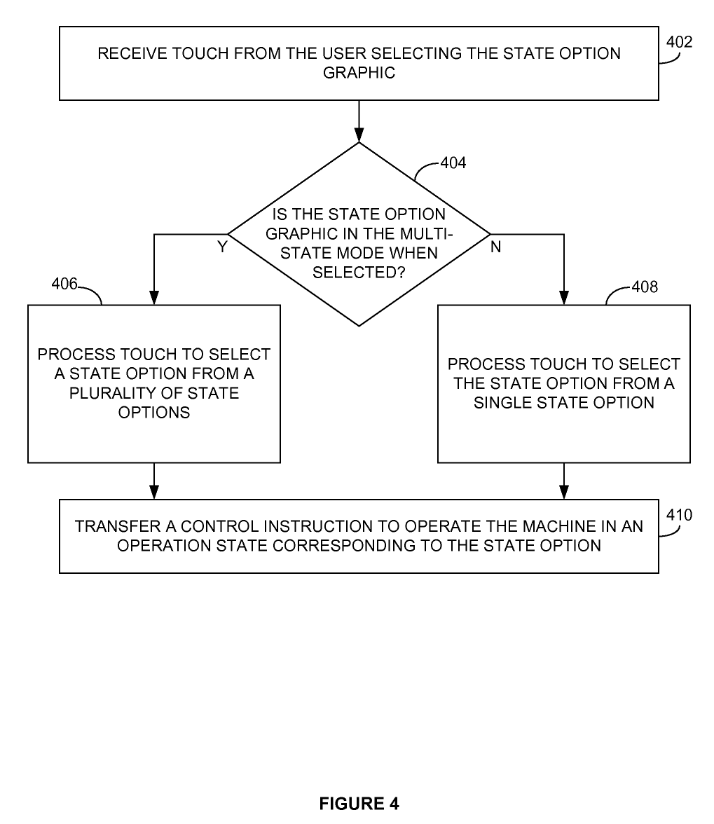

FIG. 4 is a flow diagram illustrating a method of operating industrial environment 100. HMI system 104 receives a touch from the user selecting the state option graphic (operation 402). In one embodiment, HMI system 104 comprises a user interface 205 comprising a multi-touch screen capable of accepting multiple simultaneous touches from a user. A determination is then made as to whether the state option graphic is in the multi-state mode when selected (operation 404).

If the state option graphic is in the multi-state mode when selected, HMI system 104 processes the second touch to select a state option from a plurality of state options (operation 406). The plurality of state options correspond to many different operation states of a machine. The machine referred to in operation 406 could be a machine in machine systems 101-103, which could comprise pumps, motors, robots, vats, resources, or any other element residing in industrial environment 100. For example, the available operation states for running a motor might be different rates of speed. Then, if the state option graphic is in the multi-state mode when selected, as in operation 406, selecting the state option graphic would run the motor at different speeds by toggling between the available rates of speed.

If the state option graphic is not in the multi-state mode when selected, HMI system 104 processes the second touch to select the state option from a single state option (operation 408). The single state option corresponds to a single operation state of the machine. For example, the single operation state of a resource might correspond to adding five liters of the resource to a mixture. Then, if the state option graphic is in the single-state mode when selected, as in operation 408, selecting the state option graphic would add five liters of the resource to the mixture.

In response to the user selections, HMI system 104 transfers a control instruction to operate the machine in an operation state corresponding to the state option (operation 410). If the state option corresponds to one of the plurality of operation states of the machine, as in operation 406, the control instruction will operate the machine according to the state selected from the plurality of operation states. However, if the state option corresponds to the single operation state of the machine, as in operation 408, the control instruction will operate the machine according to the single operation state.

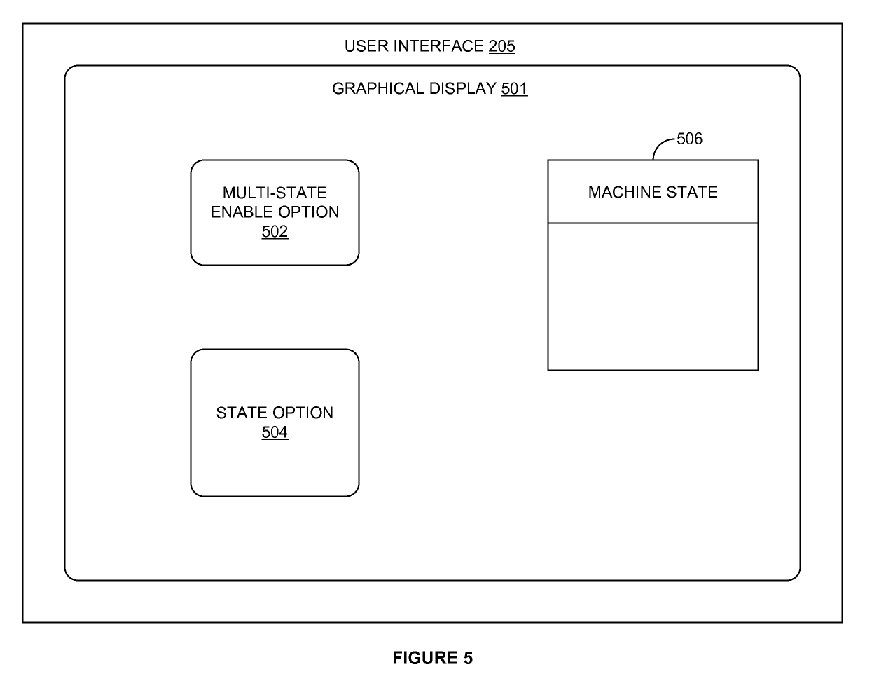

FIG. 5 is a display diagram illustrating an HMI system 104 graphical display 501 provided by user interface 205. Graphical display 501 depicts a multi-state enable option graphic 502, a state option graphic 504, and a machine state window 506. Note that graphical display 501 may display more state option graphics than the single state option graphic 504 depicted in FIG. 5. Graphical display 501 may also display graphical representations of various machine systems, such as machine systems 101-103, and a user may select one or more machine systems to be controlled by state option graphic 504. In the embodiment of FIG. 5, graphical display 501 controls a single machine system for the sake of clarity.

State option graphic 504 determines an operation state of a machine. When selected, state option graphic 504 transfers a control instruction to a machine system such as machine systems 101-103. A control system in the machine system operates the machine according to the control instruction. In another embodiment, the machine receives the control instruction and operates without the use of a control system.

Multi-state enable option graphic 502 alters the functionality of state option graphic 504. When multi-state enable option graphic 502 is not selected, state option graphic 504 operates to control a single state of a machine. When multi-state enable option graphic 502 is selected, state option graphic 502 operates to control multiple different states of a machine. The present state of operation of a machine is displayed in machine state window 506.

A user selects state option graphic 504 to operate a machine in its single state. Alternatively, the user first selects multi-state enable option graphic 502 and then uses state option graphic 504 to select one of many different multi-states of operating a machine. In one embodiment, user interface 205 comprises a touch screen and the user selects multi-state enable option graphic 502 and state option graphic 504 by providing multiple touches on user interface 205. In one embodiment, the user first touches multi-state enable option graphic 502, and then touches state option graphic 504 while continuing to touch multi-state enable option graphic 502.

In another embodiment, the user first touches multi-state enable option graphic 502, and then touches state option graphic 504 without continuing to touch multi-state enable option graphic 502. In this embodiment, state option graphic 504 operates in the multi-state mode until the user touches multi-state enable option graphic 502 a second time.

When operating in multi-state mode, a user can select the various states using state option graphic 504 in a variety of ways. In one embodiment, HMI system 104 displays a menu listing the various available multi-states, allowing the user to select one of the states from the menu. In another embodiment, the user can toggle between the various states by repeatedly touching state option graphic 504. For example, if state option graphic 504 is in multi-state mode and controls different rates of speed of a fan, touching state option graphic 504 a single time selects a slow speed, touching state option graphic 504 a second time selects a medium speed, touching state option graphic 504 a third time selects a fast speed, and touching state option graphic 504 a fourth time selects the slow speed again.

In response to the user selections, regardless of the manner in which they are provided, HMI system 104 determines the state option selected. HMI system 104 then transfers a control instruction to operate a machine in an operation state corresponding to the selected state option.

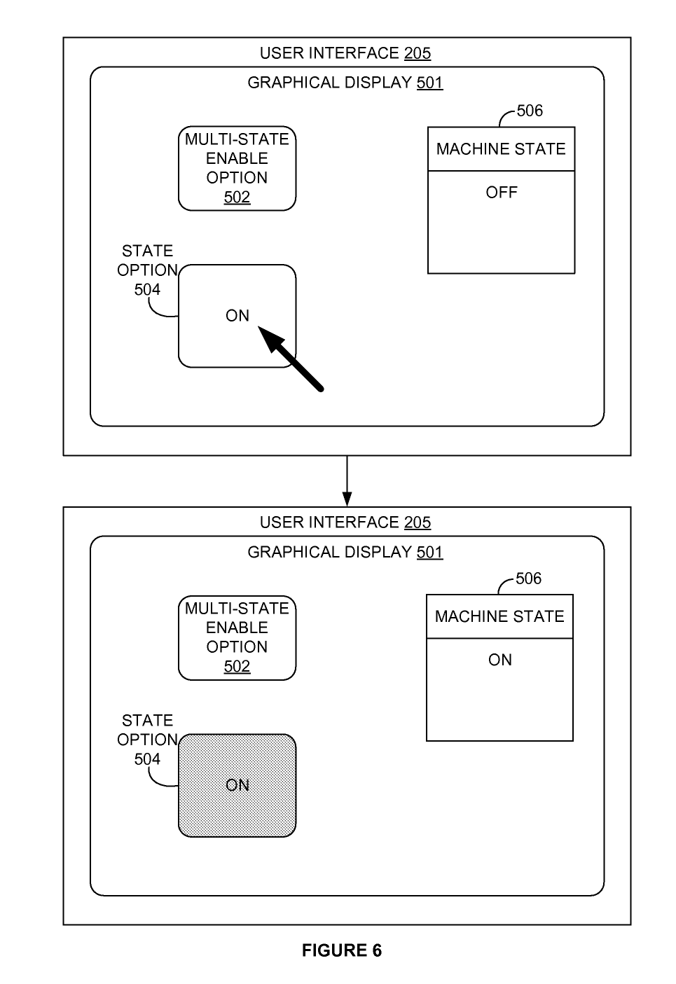

FIG. 6 is a display diagram illustrating an HMI system 104 graphical display 501 provided by user interface 205. In this embodiment, state option graphic 504 has a single state option corresponding to a single operation state of a machine. The single state option provided by state option graphic 504 turns a machine on by instructing the machine to switch from a halted state to a running state.

The upper screen image of graphical display 501 indicates the machine state is presently in the “off” state, as shown in machine state window 506. The large arrow shown in the upper screen image of graphical display 501 represents a user touching state option graphic 504.

After the user touches state option graphic 504, the lower screen image of graphical display 501 indicates the machine state has switched to the “on” state, as shown in machine state window 506. The gray shading of state option graphic 504 in the lower screen image of graphical display 501 indicates that the user has touched state option graphic 504. State option graphic 504 may control the operation of any machine capable of being controlled by HMI system 104, such as a motor, camera, robot, press, or any element residing in industrial environment 100.

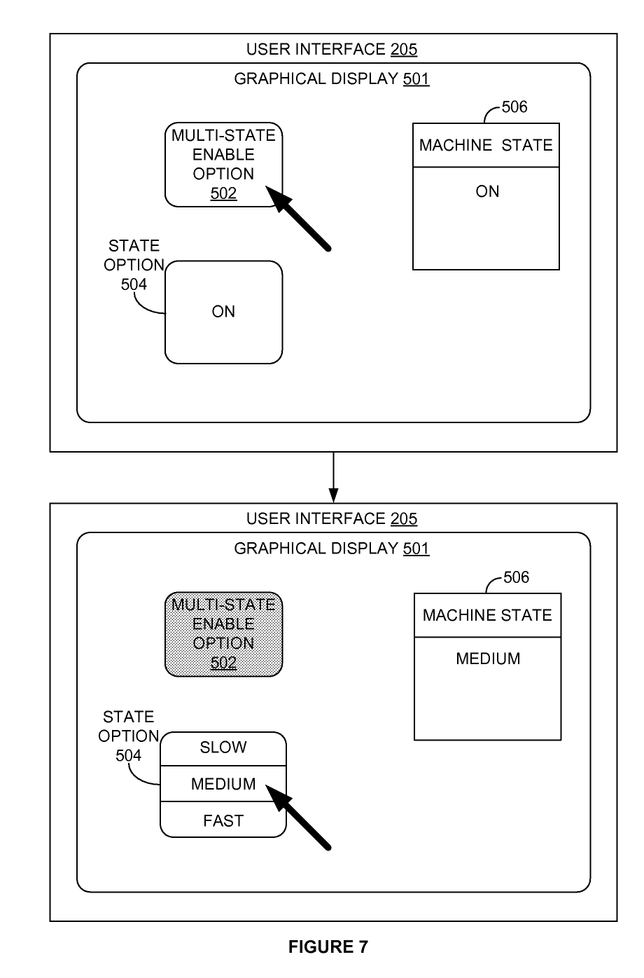

FIG. 7 is a display diagram illustrating an HMI system 104 graphical display 501 provided by user interface 205. In this embodiment, state option graphic 504 has a single state option corresponding to a single operation state of a machine. The single state option provided by state option graphic 504 turns a machine on by instructing the machine to switch from a halted state to a running state.

The upper screen image of graphical display 501 indicates the machine state is presently in the “on” state, as shown in machine state window 506. The large arrow shown in the upper screen image of graphical display 501 represents a user touching multi-state enable option graphic 502.

After the user touches multi-state enable option graphic 504, the lower screen image of graphical display 501 indicates state option graphic 504 is presently operating in the multi-state mode. The gray shading of multi-state enable option graphic 502 in the lower screen image of graphical display 501 indicates the that user has touched multi-state enable option graphic 502. In this embodiment, because the user has selected the multi-state mode, state option graphic 504 has changed from displaying the single state mode (“on”), to the various multi-states. The multi-states available to the user in this embodiment are different rates of speed for operating a machine, represented by the words “slow”, “medium”, and “fast” appearing on state option graphic 504. The large arrow shown in the lower screen image of graphical display 501 represents a user touching the “medium” speed setting of state option graphic 504. After the user touches the “medium” speed setting of state option graphic 504, the lower screen image of graphical display 501 indicates the machine state has switched to the “medium” speed state, as shown in machine state window 506.

When operating in multi-state mode, a user can select the various states using state option graphic 504 in a variety of ways. In the embodiment of FIG. 7, HMI system 104 displays a menu listing the various available multi-states, allowing the user to select one of the states from the menu. However, in another embodiment, the user can toggle between the various states by repeatedly touching state option graphic 504.

Advantageously, using the system and method described herein, a user is able to easily operate any HMI system 104 to transfer control instructions for operating machines. Examples of possible control instructions a user may select to operate machinery include a jog operation or selecting a state or mode of operation. A jog operation utilizes the interlocking of a start and stop button to control a machine. In an example, a user operating an HMI system could hold a stop button while simultaneously pressing a start button. Then, the stop button could be momentarily released, engaging the machine operation. Engaging stop again would stop the machine operation. It should be understood that a jog is a well known operation in the art. A user may also select a state or mode of operating a machine, for example a rate of speed, such as slow, medium, or fast.

A user may also control the movement of a machine. For example, the user can issue control instructions to pan or tilt a camera or robotic arm. The user could also operate a camera's zoom feature to zoom in or out, or control the operation of a robotic arm by grasping or releasing objects.

In addition, an HMI system may require combinatorial selection to prevent inadvertent touches. For example, as a safety precaution, the HMI system may require a user to place both hands, or even all ten fingers of both hands, on a user interface, prior to transferring a control instruction to operate a machine. It should be understood that not all ten fingers is required. Rather, a sufficient number of fingers touching a screen would be required, in this example, to ensure that a user has both hands engaged. For instance, at least one finger on one hand, and at least one finger on another hand would suffice to ensure that the user has both hands engaged.

The above description and associated drawings teach the best mode of the invention. The following claims specify the scope of the invention. Some aspects of the best mode may not fall within the scope of the invention as specified by the claims. Also, while the preceding discussion describes embodiments employed specifically in conjunction with the monitoring and analysis of industrial processes, other applications, such as the mathematical modeling or monitoring of any man-made or naturally-existing system, may benefit from use of the concepts discussed above. Further, those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a Human-Machine Interface (HMI) system, the method comprising:
displaying on a user interface a multi-state enable option graphic selectable by a first touch from a user, that, when the first touch is maintained, enables a multi-state mode of a state option graphic having a plurality of modes comprising a single-state mode and the multi-state mode;
displaying on the user interface the state option graphic selectable by a second touch from the user;
receiving the second touch from the user selecting the state option graphic;
if the state option graphic is in the multi-state mode when selected, processing the second touch to select a state option from a plurality of state options corresponding to a plurality of operation states of a machine;
if the state option graphic is in the single-state mode when selected, processing the second touch to select the state option from a single state option corresponding to a single operation state of the machine; and
transferring a control instruction to operate the machine in an operation state corresponding to the state option.

2. The method of claim 1 wherein the operation state is one of the plurality of operation states of the machine.

3. The method of claim 1 wherein the operation state is the single operation state of the machine.

4. The method of claim 1 wherein the operation state comprises a rate of operating the machine.

5. The method of claim 1 wherein the multi-state enable option graphic and the state option graphic comprise interlocked momentary push buttons operable to cause a jog operation of the machine.

6. The method of claim 1 wherein the operation state comprises a movement of the machine.

7. The method of claim 1 wherein the user interface comprises a multi-touch screen.

8. A Human-Machine Interface (HMI) system comprising:
a user interface configured to display a multi-state enable option graphic selectable by a first touch from a user, that, when the first touch is maintained, enables a multi-state mode of a state option graphic having a plurality of modes comprising a single-state mode and the multi-state mode, display the state option graphic selectable by a second touch from the user, and receive the second touch from the user selecting the state option graphic;
if the state option graphic is in the multi-state mode when selected, a processing system configured to process the second touch to select a state option from a plurality of state options corresponding to a plurality of operation states of a machine;
if the state option graphic is in the single-state mode when selected, the processing system configured to process the second touch to select the state option from a single state option corresponding to a single operation state of the machine; and
a machine interface configured to transfer a control instruction to operate the machine in an operation state corresponding to the state option.

9. The system of claim 8 wherein the operation state is one of the plurality of operation states of the machine.

10. The system of claim 8 wherein the operation state is the single operation state of the machine.

11. The system of claim 8 wherein the operation state comprises a rate of operating the machine.

12. The system of claim 8 wherein the operation state comprises a jog operation of the machine.

13. The system of claim 8 wherein the operation state comprises a movement of the machine.

14. The system of claim 8 wherein the user interface comprises a multi-touch screen.

15. A software product configured to operate a Human-Machine Interface (HMI) system, the software product comprising:
HMI interface software configured to direct a user interface to display a multi-state enable option graphic selectable by a first touch from a user, that, when the first touch is maintained, enables a multi-state mode of a state option graphic having a plurality of modes comprising a single-state mode and the multi-state mode, display the state option graphic selectable by a second touch from the user, and receive the second touch from the user selecting the state option graphic;
if the state option graphic is in the multi-state mode when selected, HMI operation software configured to direct a processing system to process the second touch to select a state option from a plurality of state options corresponding to a plurality of operation states of a machine;
if the state option graphic is in the single-state mode when selected, the HMI operation software configured to direct the processing system to process the second touch to select the state option from a single state option corresponding to a single operation state of the machine;
the HMI interface software configured to direct a machine interface to transfer a control instruction to operate the machine in an operation state corresponding to the state option; and
a storage system that stores the HMI operation software and the HMI interface software.

16. The software product of claim 15 wherein the operation state is one of the plurality of operation states of the machine.

17. The software product of claim 15 wherein the operation state is the single operation state of the machine.

18. The software product of claim 15 wherein the operation state comprises a rate of operating the machine.

19. The software product of claim 15 wherein the multi-state enable option graphic and the state option graphic comprise interlocked momentary push buttons operable to cause a jog operation of the machine.

20. The software product of claim 15 wherein the operation state comprises a movement of the machine.
